(19) United States
(12) Patent Application Publication
(10) Pub. No.: US 2023/0063049 A1
(43) Pub. Date: Mar. 2, 2023

(54) FUEL CELL POWER GENERATION SYSTEM AND CONTROL METHOD THEREOF

(71) Applicants: HYUNDAI MOTOR COMPANY, Seoul (KR); KIA CORPORATION, Seoul (KR)

(72) Inventor: Tae Woo Kim, Yongin-si (KR)

(73) Assignees: Hyundai Motor Company, Seoul (KR); KIA CORPORATION, Seoul (KR)

(21) Appl. No.: 17/853,383

(22) Filed: Jun. 29, 2022

(30) Foreign Application Priority Data
Sep. 2, 2021 (KR) 10-2021-0116736

(51) Int. Cl. H01M 8/04858; H01M 16/00; H02J 7/00

(52) U.S. Cl. CPC H01M 8/0488; H01M 8/0491; H01M 8/04947; H01M 16/006; H02J 7/007; H02J 7/0068; H02J 7/0048; H01M 2220/20; H01M 2250/20; H02J 2300/30; H02J 2207/20

(57) ABSTRACT

A fuel cell power generation system that is mounted in a vehicle so as to be moved to a place that needs power is provided. The fuel cell power generation system and a control method thereof are capable of supplying stable voltage to a DC-AC power converter and/or an electric vehicle charger. It is possible to maintain constant voltage of electricity that is supplied to the DC-AC power converter and the electric vehicle charger using a battery capable of outputting DC voltage higher than output voltage of a fuel cell and to perform control such that a low current density period is avoided while voltage of the fuel cell is monitored, whereby durability is improved.

This application claims the benefit of priority to Korean Patent Application No. 10-2021-0116736, filed on Sep. 2, 2021 in the Korean Intellectual Property Office, the disclosure of which is hereby incorporated by reference.

### TECHNICAL FIELD

The present disclosure relates to a fuel cell power generation system and a control method thereof, and more particularly to a fuel cell power generation system mounted in a vehicle to supply stable voltage to a DC-AC power converter and an electric vehicle charger and a control method thereof.

### BACKGROUND

At present, electrical energy is produced at a thermoelectric power plant or a hydroelectric power plant, and is supplied to buildings in various areas along power cables in order to operate televisions, fluorescent lamps, refrigerators, air conditioners, etc. Since oil or coal is burned in order to obtain electrical energy, environmental pollution occurs, and energy efficiency is very low, compared to consumption of fuel energy.

In recent years, therefore, a fuel cell, which has excellent energy efficiency and generates electrical energy in an environmentally friendly manner, has been developed. The fuel cell is a device that directly generates electrical energy from chemical energy of fuel through electrochemical reaction between fuel and air continuously supplied from the outside. Electricity generated using the fuel cell may be used as domestic AC electricity or DC electricity capable of charging an electric vehicle.

In a conventional power generation system using a fuel cell, voltage of the fuel cell is directly applied to an electric vehicle charger or a DC-AC power converter. FIG. 1 is a graph showing voltage characteristics of a fuel cell depending on output thereof. As shown, high voltage can be used in a low current density period; however, voltage is reduced in a high current density period. The higher the output of the fuel cell, therefore, the lower the voltage of power generated by the fuel cell.

In a conventional DC electricity supply device using a fuel cell, electricity generated by a fuel cell is directly supplied to a DC-AC converter and a DC electricity generation unit via a DC-DC converter. Consequently, there are problems in that voltage varies depending on output and in that voltage is lowered at high output.

In order to solve these problems, a method of controlling output voltage of the DC-DC converter to supply constant voltage has been proposed. To this end, voltage of the fuel cell is used so as to correspond to DC-DC output voltage. That is, when high voltage power is required, a low current density period of the fuel cell is used. When the fuel cell is operated in the low current density period, membrane degradation is accelerated, whereby durability is rapidly reduced.

Meanwhile, when a DC-AC power converter and an electric vehicle charger are simultaneously used, high output is required. Consequently, output of the fuel cell is increased, and therefore voltage of the fuel cell is reduced. When voltage of the fuel cell is changed according to output required by a user, voltage supplied to the DC-AC power converter and an electric vehicle charger may surge. As a result, problems occur in producing AC power having a single-phase voltage of 220V or a three-phase voltage of 380V and DC power necessary to charge an electric vehicle.

The information disclosed in the Background section above is to aid in the understanding of the background of the present disclosure, and should not be taken as acknowledgement that this information forms any part of prior art.

### SUMMARY

Accordingly, the present disclosure is directed to a fuel cell power generation system and a control method thereof that substantially obviate one or more problems due to limitations and disadvantages of the related art.

One aspect of the present disclosure is to provide a fuel cell power generation system capable of maintaining constant voltage of electricity that is supplied to a DC-AC power converter and an electric vehicle charger and a control method thereof.

Another aspect of the present disclosure is to provide a fuel cell power generation system with improved durability and a control method thereof.

The scope of the present disclosure devised to solve the problems is not limited to the aforementioned aspects, and other unmentioned aspects of the disclosure will be clearly understood by those skilled in the art based on the following detailed description of the present disclosure.

To achieve the aforementioned and other advantages and in accordance with the purpose of the disclosure, as embodied and broadly described herein, a fuel cell power generation system includes a fuel cell system configured to generate electricity through electrochemical reaction between hydrogen and oxygen, a DC-DC converter configured to step up or step down voltage of the electricity output from the fuel cell system, a voltage distributer configured to distribute current output from the DC-DC converter, a DC-AC power converter configured to convert DC electricity provided through the voltage distributer into a constant level of AC electricity, an electric vehicle charger configured to convert the DC electricity provided through the voltage distributer into a constant level of DC electricity necessary to charge an electric vehicle, a battery configured to supply power to the DC-AC power converter and/or the electric vehicle charger, and a controller configured to control output of the battery such that voltage input to the DC-AC power converter and the electric vehicle charger is maintained constant.

The fuel cell power generation system may be mounted in a transportation means so as to be movable.

Output voltage of the battery may be higher than output voltage of the fuel cell system.

Output voltage of the DC-AC power converter may be a single-phase voltage of 220V or a three-phase voltage of 380V.

The electric vehicle charger may vary a resistance value of a variable resistor to adjust the level of output DC electricity.

The controller may simultaneously drive the DC-AC power converter and the electric vehicle charger.

The battery may be charged with power output from the fuel cell system and provided through the voltage distributer.

The controller may output a signal for controlling output of the fuel cell system depending on state of charge (SOC) of the battery.

The controller may perform control such that a low current density period is avoided while voltage of the fuel cell is monitored.

In accordance with another aspect of the present disclosure, there is provided a control method of a fuel cell power generation system, the control method including a first step of driving a fuel cell system to produce DC power, a second step of controlling a DC-DC converter to step up or step down voltage of electricity output from the fuel cell system, a third step of checking a set state of a domestic power charging switch and an electric vehicle charging switch, and a fourth step of performing control such that voltage provided to a DC-AC power converter and/or an electric vehicle charger is maintained constant using electricity provided from a battery depending on the result of checking in the third step.

Charging operation may be controlled depending on the state in which the domestic power charging switch and the electric vehicle charging switch are simultaneously ON, the state in which both the domestic power charging switch and the electric vehicle charging switch are OFF, or the state in which one of the domestic power charging switch and the electric vehicle charging switch is ON.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a graph showing output characteristics of a fuel cell;

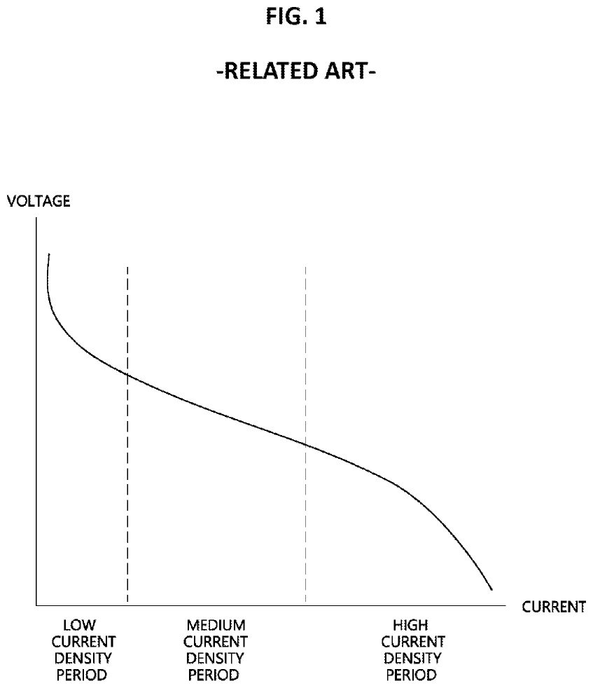

FIG. 2 is an illustrative view showing an example in which a fuel cell power generation system according to one exemplary embodiment of the present disclosure is mounted in a cargo box of a vehicle.

FIG. 3 is a block diagram schematically showing the construction of the fuel cell power generation system according to one exemplary embodiment of the present disclosure;

FIG. 4 is a graph showing an output voltage range of a fuel cell and an output voltage range of a high voltage battery in the fuel cell power generation system according to one exemplary embodiment of the present disclosure;

FIG. 5 is a flowchart showing a control method of the fuel cell power generation system according to one exemplary embodiment of the present disclosure;

FIG. 6 is a flowchart concretely showing control operation of the fuel cell power generation system according to one exemplary embodiment of the present disclosure based on a set state of a charging switch;

FIG. 7 is an illustrative view showing a control signal and a connection state of electricity when an electric vehicle is charged using the fuel cell power generation system according to one exemplary embodiment of the present disclosure;

FIG. 8 is an illustrative view showing a control signal and a connection state of electricity when a domestic power device is charged using the fuel cell power generation system according to one exemplary embodiment of the present disclosure; and

FIG. 9 is an illustrative view showing a control signal and a connection state of electricity when the domestic power device and the electric vehicle are simultaneously charged using the fuel cell power generation system according to one exemplary embodiment of the present disclosure.

### DETAILED DESCRIPTION

Specific structural or functional descriptions of the embodiments of the present disclosure disclosed in this specification are given only for illustrating embodiments of the present disclosure. Embodiments of the present disclosure may be realized in various forms, and should not be interpreted to be limited to the embodiments of the present disclosure disclosed in this specification.

Since the embodiments of the present disclosure may be variously modified and may have various forms, specific embodiments will be shown in the drawings and will be described in detail in this specification. However, the embodiments according to the concept of the present disclosure are not limited to such specific embodiments, and it should be understood that the present disclosure includes all alterations, equivalents, and substitutes that fall within the idea and technical scope of the present disclosure.

It will be understood that, although the terms “first”, “second”, etc. may be used herein to describe various elements, corresponding elements should not be understood to be limited by these terms, which are used only to distinguish one element from another. For example, within the scope defined by the present disclosure a first element may be referred to as a second element, and similarly, a second element may be referred to as a first element.

It will be understood that, when a component is referred to as being “connected to” or “coupled to” another component, it may be directly connected to or coupled to the other component, or intervening components may be present. In contrast, when a component is referred to as being “directly connected to” or “directly coupled to” another component, there are no intervening components present. Other terms that describe the relationship between components, such as “between” and “directly between” or “adjacent to” and “directly adjacent to”, must be interpreted in the same manner.

The terms used in this specification are provided only to explain specific embodiments, but are not intended to restrict the present disclosure. A singular representation may include a plural representation unless it represents a definitely different meaning from the context. It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof.

Unless otherwise defined, all terms, including technical and scientific terms, used in this specification have the same meanings as those commonly understood by a person having ordinary skill in the art to which the present disclosure pertains. It will be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

Meanwhile, in the case in which a certain embodiment is differently realized, a function or operation specified in a specific block may be performed differently from the sequence specified in a flowchart. For example, two continuous blocks may be substantially simultaneously performed, or the blocks may be performed in reverse order depending on related functions or operations.

Hereinafter, a fuel cell power generation system according to various exemplary embodiments of the present disclosure and a control method thereof will be described in detail with reference to the accompanying drawings.

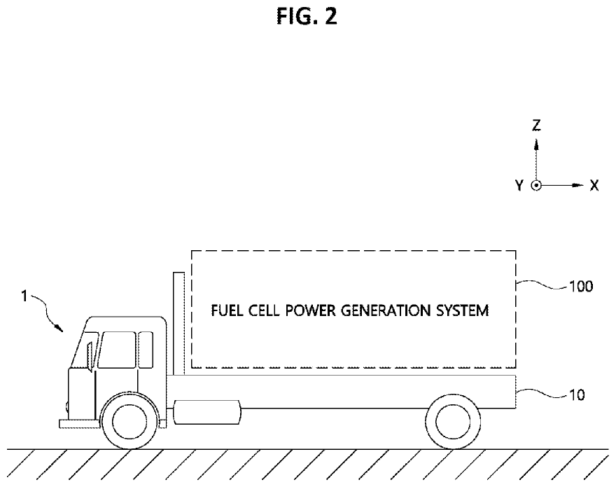

FIG. 2 is an illustrative view showing an example in which a fuel cell power generation system according to one exemplary embodiment of the present disclosure is mounted in a cargo box of a vehicle. As shown, the fuel cell power generation system 100 according to the present disclosure is movable in a state of being mounted in a cargo space of a transportation means, such as a cargo box 10 of a vehicle 1 as the transportation means. In the following description, a vehicle will be mentioned as an example of the transportation means. However, the present disclosure is not limited thereto as long as the transportation means has a space in which the fuel cell power generation system can be mounted. The fuel cell power generation system 100 according to the present disclosure may be mounted in the transportation means so as to move to a place at which a device that requires power is located and to supply power to the device.

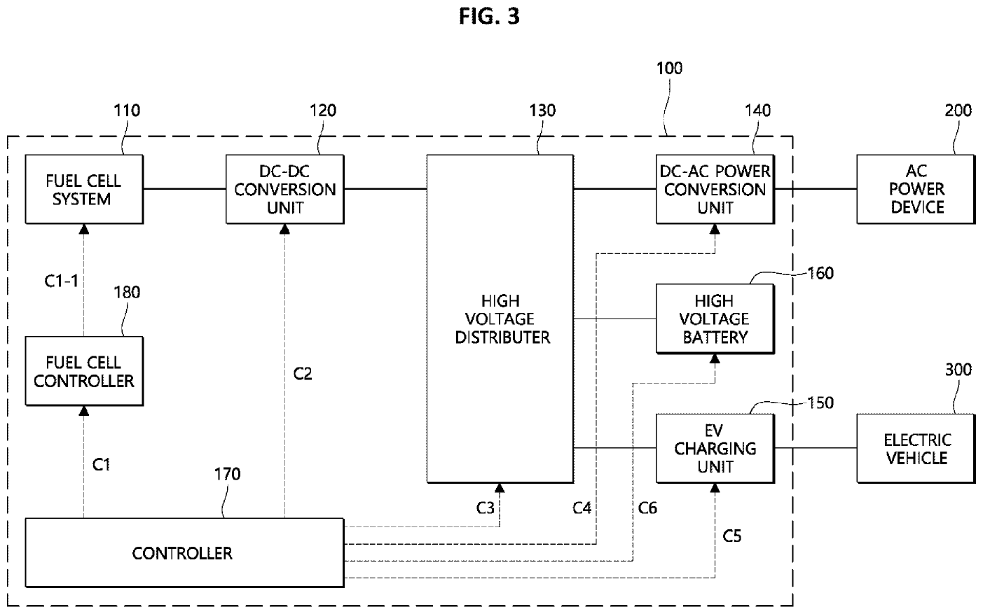

FIG. 3 is a block diagram schematically showing the construction of the fuel cell power generation system according to one exemplary embodiment of the present disclosure. As shown, the fuel cell power generation system includes a fuel cell system 110, a DC-DC converter 120, a high voltage distributer 130, a DC-AC power converter 140, an electric vehicle (EV) charger 150, a high voltage battery 160, a controller 170, and a fuel cell controller 180. Meanwhile, although not shown, a charging switch configured to allow use of the fuel cell power generation system according to the present disclosure may be disposed. That is, each of a first switch SW1 used to charge an AC power device 200 and a second switch SW2 used to charge an electric vehicle 300 may be set to be in a turned-on state or a turned-off state.

The fuel cell system 110 generates electricity through electrochemical reaction between hydrogen and oxygen. The fuel cell system 110 may be constituted by a module type power module complete (PMC). The fuel cell system 110 may be constituted by a single module (PMC) or a plurality of modules (PMC) connected to each other in parallel. The fuel cell system 110 includes a fuel cell stack constituted by a plurality of stacked fuel cells, a fuel supply system configured to supply hydrogen, which is a fuel, to the fuel cell stack, an air supply system configured to supply oxygen, which is an oxidizer necessary for chemical reaction, and a heat management system configured to control temperature of the fuel cell stack.

The fuel supply system decompresses compressed hydrogen stored in a hydrogen storage unit and supplies the decompressed hydrogen to a fuel electrode (anode) of the fuel cell stack, and the air supply system supplies external air suctioned by an air blower to an air electrode (cathode) of the fuel cell stack. When hydrogen is supplied to the fuel electrode of the fuel cell stack and oxygen is supplied to the air electrode of the fuel cell stack, hydrogen ions are separated from the fuel electrode through catalyst reaction. The separated hydrogen ions are transferred to the air electrode, i.e. the cathode, through an electrolyte membrane, and the hydrogen ions separated from the fuel electrode, electrons, and oxygen electrochemically react with each other at the cathode, whereby electrical energy may be obtained. Specifically, hydrogen is electrochemically oxidized at the fuel electrode, and oxygen is electrochemically reduced at the air electrode. At this time, electricity and heat are generated due to movement of the electrons, and vapor or water is generated due to chemical reaction between hydrogen and oxygen. A discharge device is provided to discharge byproducts, such as vapor, water, and heat, generated in an electrical energy generation process of the fuel cell stack and unreacted hydrogen and oxygen. Gases, such as vapor, hydrogen, and oxygen, are discharged to the air through an exhaust passage.

The DC-DC converter 120 steps up or steps down voltage of electricity generated by the fuel cell system 110.

The high voltage distributer 130 distributes the electricity stepped up/stepped down by the DC-DC converter 120. The high voltage distributer 130 distributes stepped-up power to the DC-AC power converter 140, the EV charger 150, and the high voltage battery 160.

The DC-AC power converter 140 converts DC electricity provided through the high voltage distributer 130 into AC electricity and provides the AC electricity to the external AC power device 200.

The electric vehicle charger 150 converts DC electricity provided through the high voltage distributer 130 into a constant level of DC electricity necessary to charge the electric vehicle 300.

The high voltage battery 160 supplies power to the high voltage distributer 130 such that power having constant voltage is supplied to the DC-AC power converter and/or the electric vehicle charger according to a control signal of the controller 170. Output voltage of the high voltage battery 160 is higher than output voltage of the fuel cell system 110. For example, when output voltage of the fuel cell system 110 is 200V to 400V, output voltage of the high voltage battery 160 may be 600V to 800V. However, the present disclosure is not limited thereto. In addition, a secondary battery configured to be charged with power output from the fuel cell system 110 and provided through the high voltage distributer 130 may be used as the high voltage battery 160.

The controller 170 provides a control signal to a component of the fuel cell power generation system in order to control output of the high voltage battery 160 such that voltage input to the DC-AC power converter 140 and the electric vehicle charger 150 is maintained constant.

The fuel cell controller 180 generates a signal for control operation of the fuel cell system 110 in response to the control signal of the controller 170.

In the present disclosure, it is possible to solve surge of voltage supplied to the DC-AC power converter 140 and the electric vehicle charger 150 using the high voltage battery 160 having a higher voltage band than output voltage of the fuel cell system 110. That is, in the fuel cell power generation system 100 according to the present disclosure, voltage supplied to the DC-AC power converter 140 and the electric vehicle charger 150 is not stepped-up voltage of electricity generated by the fuel cell system 110 but voltage of the high voltage battery 160, whereby stable supply of voltage is achieved.

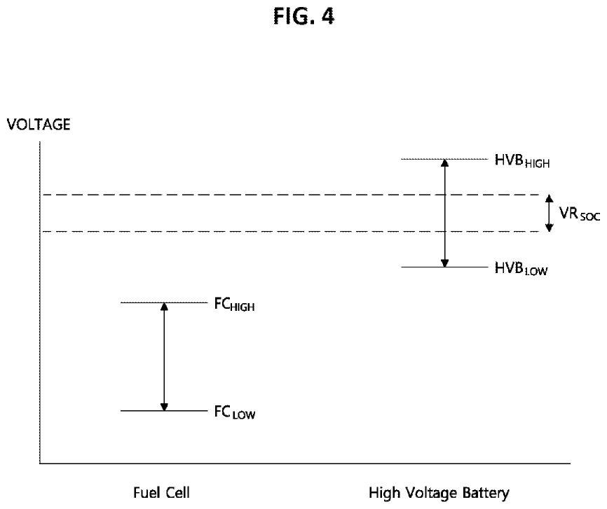

In addition, the controller 170 controls state of charge (SOC) of the high voltage battery 160. Consequently, it is possible to apply constant voltage to the DC-AC power converter 140 and the electric vehicle charger 150 irrespective of output of the fuel cell system 110. FIG. 4 is a graph showing an output voltage range of the fuel cell and an output voltage range of the high voltage battery in the fuel cell power generation system according to one exemplary embodiment of the present disclosure. Output voltage of the fuel cell system 110 has a range from the minimum voltage (fuel cell low voltage) FC_{Low} to the maximum voltage (fuel cell high voltage) FC_{High} In contrast, output voltage of the high voltage battery 160 has a range from the minimum output voltage HVB_{Low} to the maximum output voltage HVB_{High}. Possible output voltage VR_{SoC} of the high voltage battery 160 may be varied according to the control signal of the controller 170 depending on the state of charge (SOC) thereof.

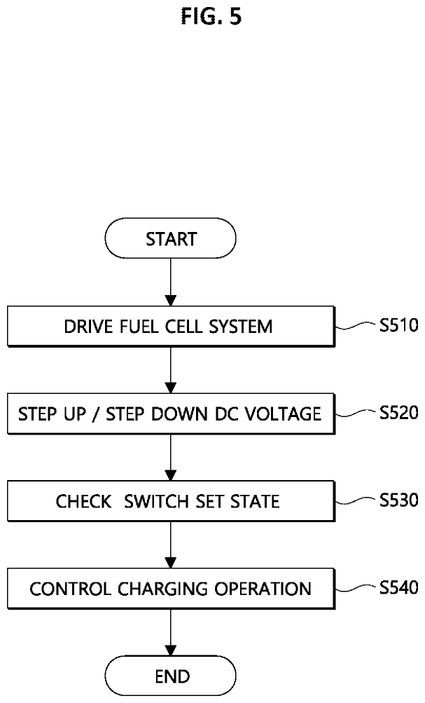

FIG. 5 is a flowchart showing a control method of the fuel cell power generation system according to one exemplary embodiment of the present disclosure. In the following description, the controller of the fuel cell power generation system will be described as an operation agent. First, the controller performs control such that the fuel cell system produces DC power. The controller 170 outputs a control signal Cl for producing power using the fuel cell system 110 to the fuel cell controller 180. The fuel cell controller 180 outputs a control signal C1-1 necessary to drive the fuel cell system 110. Upon receiving the control signal C1-1 of the fuel cell controller 180, the fuel cell system 110 generates DC electricity using hydrogen fuel supplied from the hydrogen storage unit and air (S510).

The controller controls the DC-DC converter to step up or step down voltage of electricity output from the fuel cell system so as to be used by a device connected to the fuel cell power generation system according to the present disclosure. The controller outputs a control signal C2 for step-up or step-down to the DC-DC converter 120. The DC-DC converter 120 steps up or steps down the DC electricity generated by the fuel cell system 110 and transmits the stepped-up or stepped-down DC electricity to the high voltage distributer 130 (S520).

The controller checks set states of the domestic power charging switch SW1 and the electric vehicle charging switch SW2 (S530), and performs control such that voltage provided to the DC-AC power converter and/or the electric vehicle charger is maintained constant using electricity provided from the high voltage battery depending on the result of checking (S540).

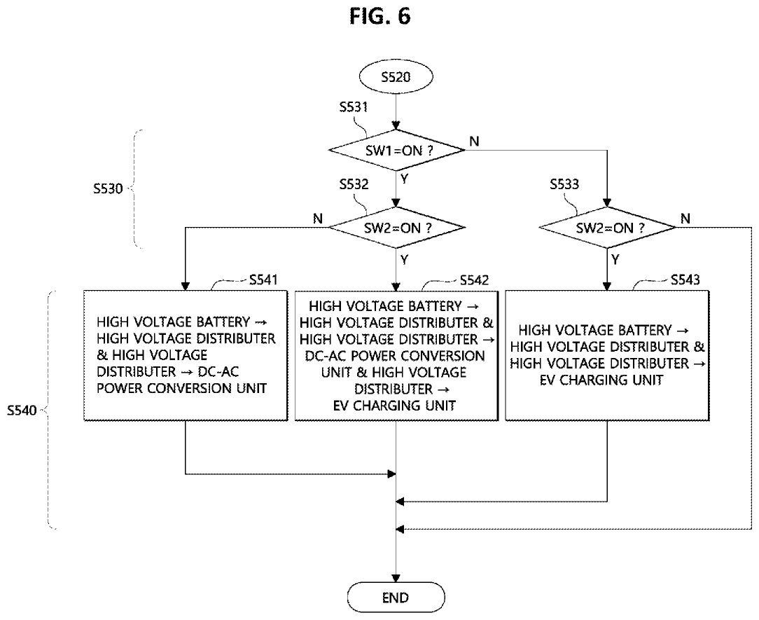

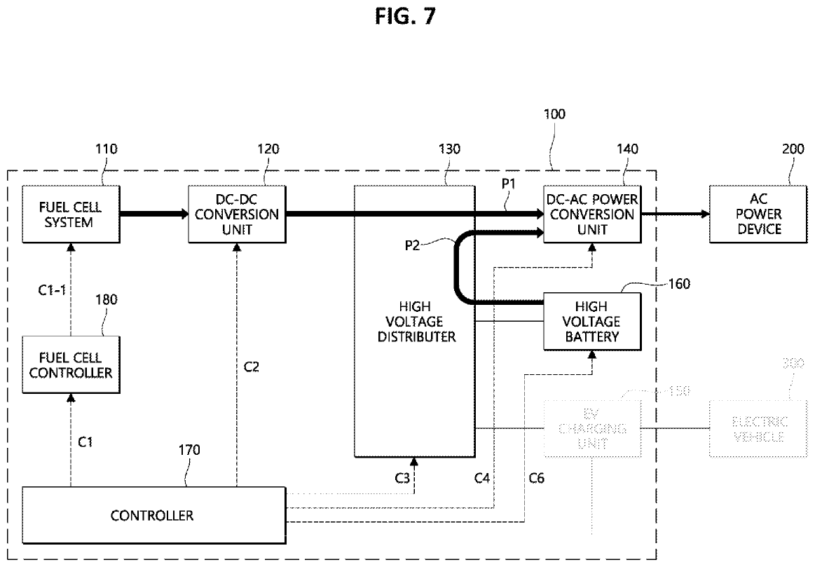

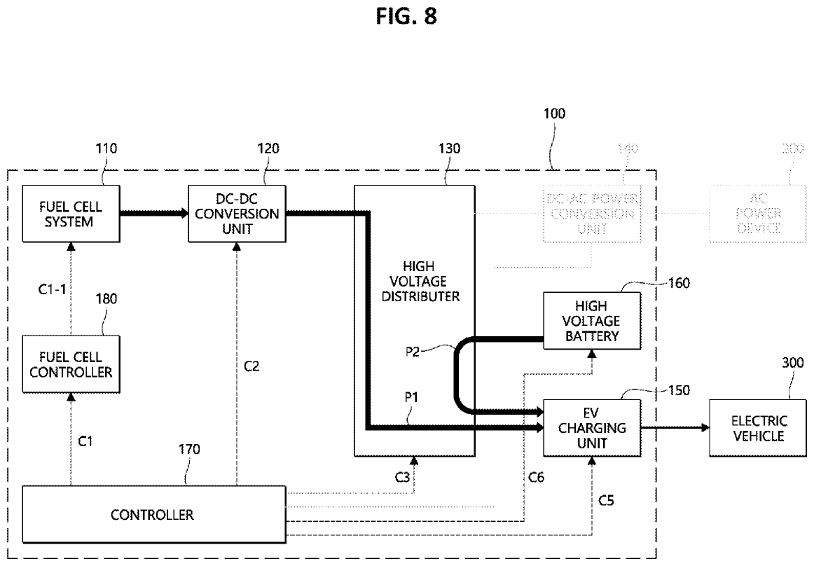

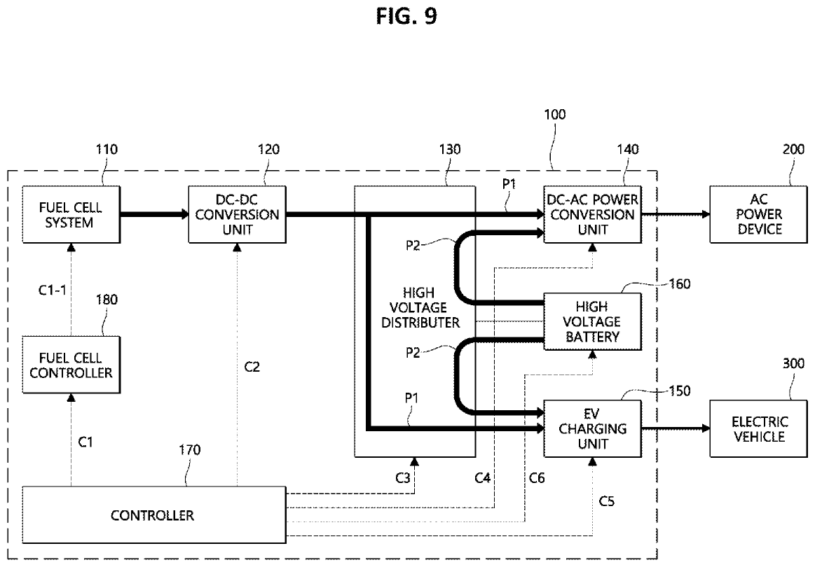

FIG. 6 is a flowchart concretely showing control operation of the fuel cell power generation system according to one exemplary embodiment of the present disclosure based on a set state of the charging switch, FIG. 7 is an illustrative view showing a control signal and a connection state of electricity when an electric vehicle is charged using the fuel cell power generation system according to one exemplary embodiment of the present disclosure, FIG. 8 is an illustrative view showing a control signal and a connection state of electricity when a domestic power device is charged using the fuel cell power generation system according to one exemplary embodiment of the present disclosure, and FIG. 9 is an illustrative view showing a control signal and a connection state of electricity when the domestic power device and the electric vehicle are simultaneously charged using the fuel cell power generation system according to one exemplary embodiment of the present disclosure.

The controller determines whether the set state of the domestic power charging switch SW1 is an ON state (S531).

Upon determining that the set state of the domestic power charging switch SW1 is an ON state, the controller determines whether the set state of the electric vehicle charging switch SW2 is an ON state (S532).

Upon determining that the set state of the domestic power charging switch SW1 is an OFF state, the controller determines whether the set state of the electric vehicle charging switch SW2 is an ON state (S533).

When the set state of the domestic power charging switch SW1 is an ON state but the set state of the electric vehicle charging switch SW2 is an OFF state, the controller performs control such that a single-phase voltage of 220V or a three-phase voltage of 380V is output through the DC-AC power converter 140 (S541). That is, as shown in FIG. 7, the controller 170 outputs a signal for controlling the fuel cell controller 180, the DC-DC converter 120, the high voltage distributer 130, the DC-AC power converter 140, and the high voltage battery 160.

Electricity generated by the fuel cell system 110 is stepped up by the DC-DC converter 120. The controller 170 outputs a control signal C6 to the high voltage battery 160 in order to provide power of the high voltage battery 160 to the high voltage distributer 130. The controller 170 outputs a control signal C3 such that the high voltage distributer 130 provides output power P1 stepped-up by the DC-DC converter 120 and battery power P2 provided from the high voltage battery 160 to the DC-AC power converter 140. The DC-AC power converter 140 generates AC power usable in the AC power device 200 using power input by a control signal C4 provided from the controller 170.

When the set state of the domestic power charging switch SW1 is an OFF state but the set state of the electric vehicle charging switch SW2 is an ON state, the controller 170 performs control such that the electric vehicle charger 150 varies the resistance value of a variable resistor to output an adjusted level of DC power (S543). That is, as shown in FIG. 8, the controller 170 outputs a signal for controlling the fuel cell controller 180, the DC-DC converter 120, the high voltage distributer 130, the electric vehicle charger 150, and the high voltage battery 160.

Electricity generated by the fuel cell system 110 is stepped up by the DC-DC converter 120. The controller 170 outputs a control signal C6 to the high voltage battery 160 in order to provide power of the high voltage battery 160 to the high voltage distributer 130. The controller 170 outputs a control signal C3 such that the high voltage distributer 130 provides output power P1 stepped-up by the DC-DC converter 120 and battery power P2 provided from the high voltage battery 160 to the electric vehicle charger 150. The electric vehicle charger 150 generates DC power necessary to charge the electric vehicle 300 using power input by a control signal C5 provided from the controller 170.

When the set state of each of the domestic power charging switch SW1 and the electric vehicle charging switch SW2 is an ON state, the controller 170 performs control such that a single-phase voltage of 220V or a three-phase voltage of 380V is output through the DC-AC power converter 140 and such that the electric vehicle charger 150 outputs DC power necessary to charge the electric vehicle, as shown in FIG. 9 (S542). That is, as shown in FIG. 9, the controller 170 outputs a signal for controlling the fuel cell controller 180, the DC-DC converter 120, the high voltage distributer 130, the DC-AC power converter 140, the electric vehicle charger 150, and the high voltage battery 160.

The controller 170 outputs a control signal C6 to the high voltage battery 160 in order to provide power of the high voltage battery 160 to the high voltage distributer 130.

The controller 170 outputs a control signal C3 such that the high voltage distributer 130 provides output power P1 stepped-up by the DC-DC converter 120 and battery power P2 provided from the high voltage battery 160 to the DC-AC power converter 140 and such that the high voltage distributer 130 provides output power P1 stepped-up by the DC-DC converter 120 and battery power P2 provided from the high voltage battery 160 to the electric vehicle charger 150.

The DC-AC power converter 140 generates AC power usable in the AC power device 200 using power input by a control signal C4 provided from the controller 170. The electric vehicle charger 150 generates DC power necessary to charge the electric vehicle 300 using power input by a control signal C5 provided from the controller 170.

In the fuel cell power generation system according to the present disclosure and the control method thereof, as described above, voltage of electricity supplied to the DC-AC power converter and the electric vehicle charger may be maintained constant using the high voltage battery capable of outputting higher DC voltage than output voltage of the fuel cell, and control is performed such that a low current density period is avoided while voltage of the fuel cell is monitored, whereby durability is improved.

As is apparent from the above description, a fuel cell power generation system according to the present disclosure and a control method thereof have effects in that voltage of electricity supplied to a DC-AC power converter and an electric vehicle charger is maintained constant and in that control is performed such that a low current density period is avoided while voltage of a fuel cell is monitored, whereby durability is improved.

Although the preferred embodiments of the present disclosure have been described above with reference to the accompanying drawings, those skilled in the art will appreciate that various modifications and alterations are possible without departing from the idea and field of the present disclosure set forth in the appended claims.

What is claimed is:

1. A fuel cell power generation system comprising:
a fuel cell system configured to generate electricity through electrochemical reaction between hydrogen and oxygen;
a DC-DC converter configured to step up or step down voltage of the electricity output from the fuel cell system;
a voltage distributer configured to distribute current output from the DC-DC converter;
a DC-AC power converter configured to convert DC electricity provided through the voltage distributer into a constant level of AC electricity;
an electric vehicle charger configured to convert the DC electricity provided through the voltage distributer into a constant level of DC electricity to charge an electric vehicle;
a battery configured to supply power to the DC-AC power converter and/or the electric vehicle charger; and
a controller configured to control output of the battery such that voltage input to the DC-AC power converter and/or the electric vehicle charger is maintained constant.

2. The fuel cell power generation system according to claim 1, wherein the fuel cell power generation system is mounted on a transportation means so as to be movable.

3. The fuel cell power generation system according to claim 1, wherein output voltage of the battery is higher than output voltage of the fuel cell system.

4. The fuel cell power generation system according to claim 1, wherein output voltage of the DC-AC power converter is a single-phase voltage of 220V or a three-phase voltage of 380V.

5. The fuel cell power generation system according to claim 1, wherein the electric vehicle charger adjusts a level of output DC electricity by varying a resistance value of a variable resistor.

6. The fuel cell power generation system according to claim 1, wherein the controller simultaneously drives the DC-AC power converter and the electric vehicle charger.

7. The fuel cell power generation system according to claim 1, wherein the battery is charged with power output from the fuel cell system and provided through the voltage distributer.

8. The fuel cell power generation system according to claim 7, wherein the controller outputs a signal for controlling output of the fuel cell system depending on state of charge (SOC) of the battery.

9. A control method of a fuel cell power generation system, the control method comprising:
a first step of driving a fuel cell system to produce DC power;
a second step of controlling a DC-DC converter to step up or step down voltage of electricity output from the fuel cell system;
a third step of checking a set state of a domestic power charging switch and an electric vehicle charging switch; and
a fourth step of performing control such that voltage provided to a DC-AC power converter and/or an electric vehicle charger is maintained constant using electricity provided from a battery depending on a result of checking in the third step.

10. The control method according to claim 9, wherein the third step is performed to check any one of:
a state in which the domestic power charging switch and the electric vehicle charging switch are simultaneously ON;
a state in which the domestic power charging switch is ON and the electric vehicle charging switch is OFF;
a state in which the electric vehicle charging switch is ON and the domestic power charging switch is OFF; or
a state in which both the domestic power charging switch and the electric vehicle charging switch are OFF.

11. The control method according to claim 9, wherein output voltage of the battery is higher than output voltage of the fuel cell system.

12. The control method according to claim 9, wherein the second step is performed to control output of the fuel cell system depending on state of charge (SOC) of the battery.

13. The control method according to claim 9, wherein the battery is charged with electricity generated by the fuel cell system.

14. The control method according to claim 9, wherein, in the fourth step, a single-phase voltage of 220V or a three-phase voltage of 380V is output through the DC-AC power converter.

15. The control method according to claim 9, wherein, in the fourth step, a resistance value of a variable resistor of the electric vehicle charger is varied to adjust a level of output DC electricity.
